(19) United States
(12) Patent Application Publication
(10) Pub. No.: US 2004/0177189 A1
(43) Pub. Date: Sep. 9, 2004

(54) Method and system of processing a media file

(76) Inventor: Armand Victor Wemelsfelder, Hilversum (NL)

Correspondence Address: Corporate Patent Counsel, Philips Electronics North America Corporation, P O Box 3001, Briarcliff Manor, NY, 10510, US

(21) Appl. No.: 10/482,148

(22) PCT Filed: Jun. 20, 2002
(86) PCT No.: PCT/IB02/02546

(30) Foreign Application Priority Data
Jun. 7, 2001 (EP) 012002610.0

(51) Int. Cl. G06F 12/00; G06F 12/14

(52) U.S. Cl. 710/200

(57) ABSTRACT

Streaming applications can often be divided into a plurality of tasks that can be processed by a multi-processor system. Those tasks are connected to each other through queues (102,104) comprising the data to be processed by the task (100). In order to synchronize the access of the data over the different processors, a method is provided that acquires a semaphore (118) that guards the task itself and the changing of predefined states of packets that comprise the data within a queue.

The invention relates to a method of processing a media file, the method comprising at least one processing step that is executed by a plurality of processors and the at least one processing step comprising processing data.

Furthermore the invention relates to a system for processing a media file, the system comprising:

a plurality of processor means conceived to execute at least one processing step performed upon processing data, the processing step comprising reading and/or writing the processing data;

reading from first queue means conceived to comprise a first processing packet wherein the first processing packet comprises the processing data.

An embodiment of the method as set forth above is known from WO 99/22296. Here, semaphore-based synchronization is executed among a first station and one or more second stations. For each station a single bivalent semaphore is provided. The first station checks all second station semaphores as having a second state relative to its own semaphore's first state. It then executes a first accessing operation and flips the first state. Otherwise it foregoes the first accessing operation. The second station checks the first station semaphore as having the second state relative to its own semaphore's second state. It then executes a second accessing operation and flips the latter state. Otherwise it foregoes the second accessing operation. However, each station must check the other station's semaphore before deciding upon execution. Therefore, each station must know the next station or next processing step within the network of processing steps, which creates dependencies between the processing steps that lead to a less flexible architecture.

It is an object of the current invention to provide a method that acquires packets in an improved way and allows a more flexible architecture. To achieve this object, the method of processing a media file according to the preamble is characterized in that the at least one processing step further comprises:

a first step of claiming by one of the plurality of processors a semaphore that guards the at least one processing step;

a second step of acquiring a first processing packet from a first queue, wherein the first processing packet comprises the processing data;

a third step of waiting until the first processing packet has a first predefined state of a plurality of predefined states;

a fourth step of changing the first predefined input state of the first processing packet into a second predefined state of the plurality of predefined states;

a fifth step of releasing the semaphore by the one of the plurality of processors;

a sixth step of processing the media file comprising reading and/or writing of the processing data;

a seventh step of changing the second predefined state of the first processing packet into a third predefined state of the plurality of predefined states.

By claiming a semaphore that guards a processing step before acquiring a first packet from a queue, the first packet and a corresponding update of a pointer indicating a next packet to be acquired can be claimed within one atomic action. This prevents other processors from acquiring the same packets at the same time which can lead to not preserving the sequence in which the packets from the queue are to be processed. Furthermore, by waiting for a predefined state for the first packet, processing the first packet is performed with the correct content of the first packet. By de-coupling each processing step via queues, the processing steps are not aware of each other, which leads to a more flexible architecture, in which the queue and first packet can act as the input or output queue for a processing step.

An embodiment of the method according to the invention is described in claim 2. By acquiring a second packet in addition to acquiring the first packet within the guard of the claimed semaphore, the sequence in which the result from processing the contents of the first packet is stored within a second packet is preserved. Furthermore, a possible previous content of the second packet is not written with new content before it is allowed to re-write the second packet. Since processing data is performed outside the guard of the semaphore, other processors are not stalled until the first processor has finished processing all the data.

Within a streaming architecture, the first queue and first packet can be considered the input queue and the input packet for the processing step whereas the second queue and second packet can be considered the output queue and output packet.

An embodiment of the method according to the invention is described in claim 3. By updating shared memory within the guard of the semaphore, the updated content of the shared memory becomes available to all relevant processors simultaneously and is consistent with the content of the acquired input and output packets. Since the update is performed within the guard of the semaphore, reading from and writing to the shared memory by a processing step is performed within an atomic action.

Furthermore, it is an object of the current invention to provide a system that acquires packets in an improved way and allows a more flexible architecture. To achieve this object, the system for processing a media file according to the preamble is characterized in that the system further comprises:

semaphore means conceived to guard the processing step by one of the plurality of processors;

state means conceived to comprise a first predefined state of a plurality of predefined states;

waiting means conceived to wait for a first predefined state for the input packet; and

changing means conceived to change the first predefined state into a second predefined state of the plurality of predefined states.

An embodiment of the system for decoding a media file according to the invention is described in claim 5.

The invention will be described by means of embodiments illustrated by the following drawings:

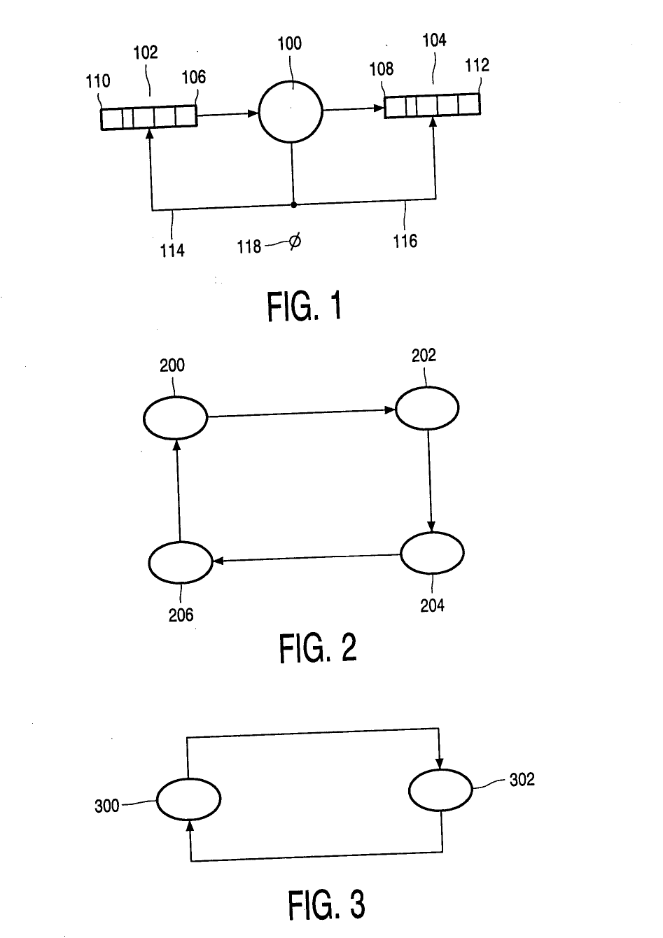

FIG. 1 illustrates a task that reads data from an input queue and writes processed data to an output queue;

FIG. 2 illustrates a state per packet;

FIG. 3 illustrates the states of the task's semaphore;

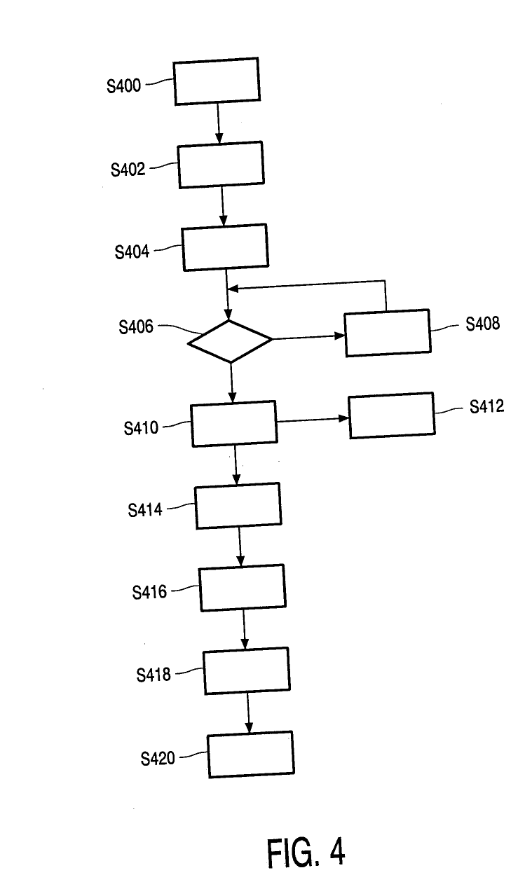

FIG. 4 illustrates the main steps of the method according to the invention;

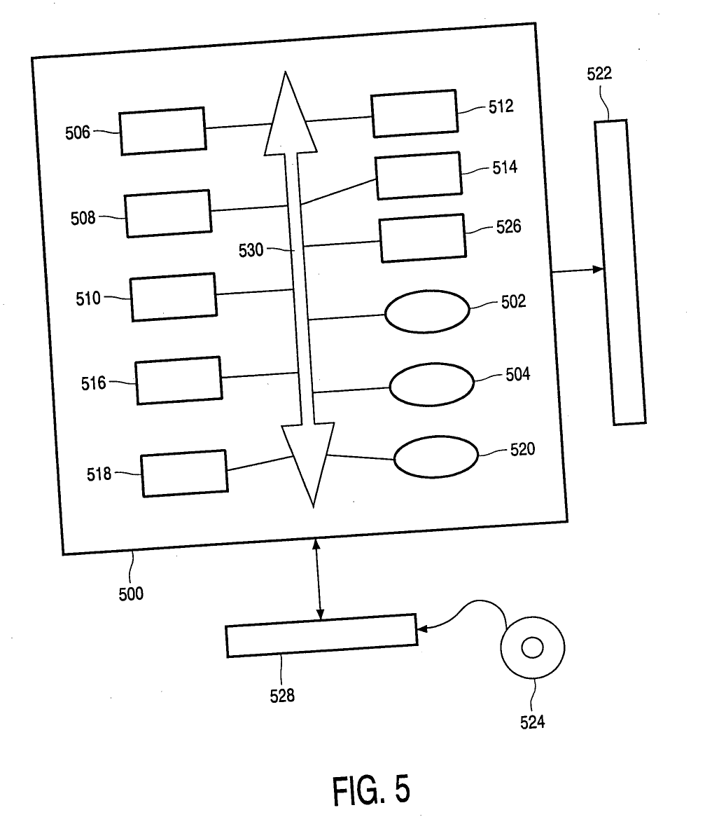

FIG. 5 illustrates the main parts of a system according to the invention in a schematic way;

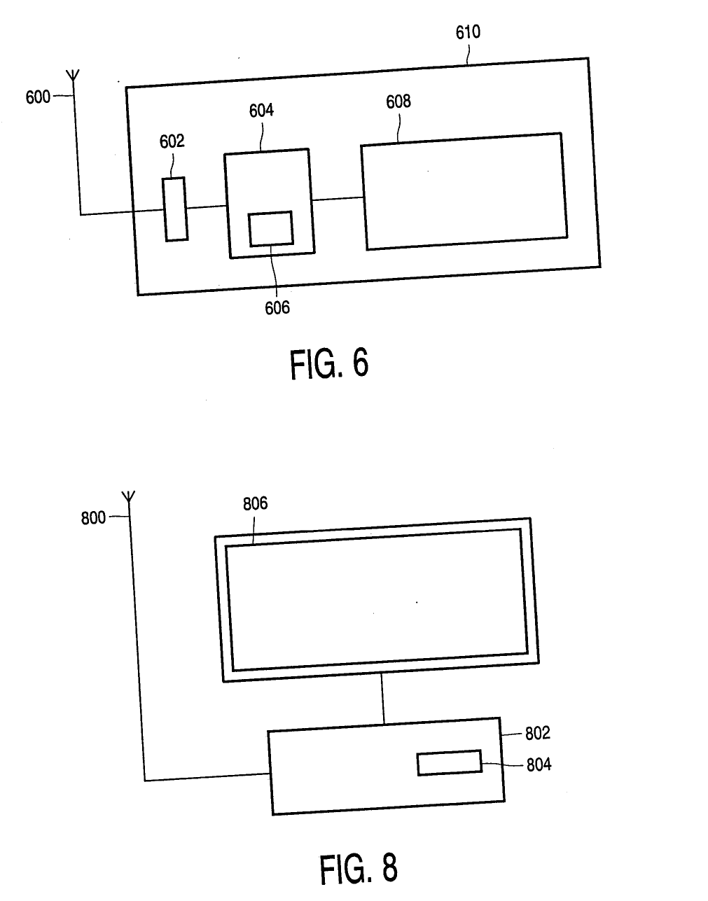

FIG. 6 illustrates a television set in a schematic way that comprises an embodiment of the system according to the invention;

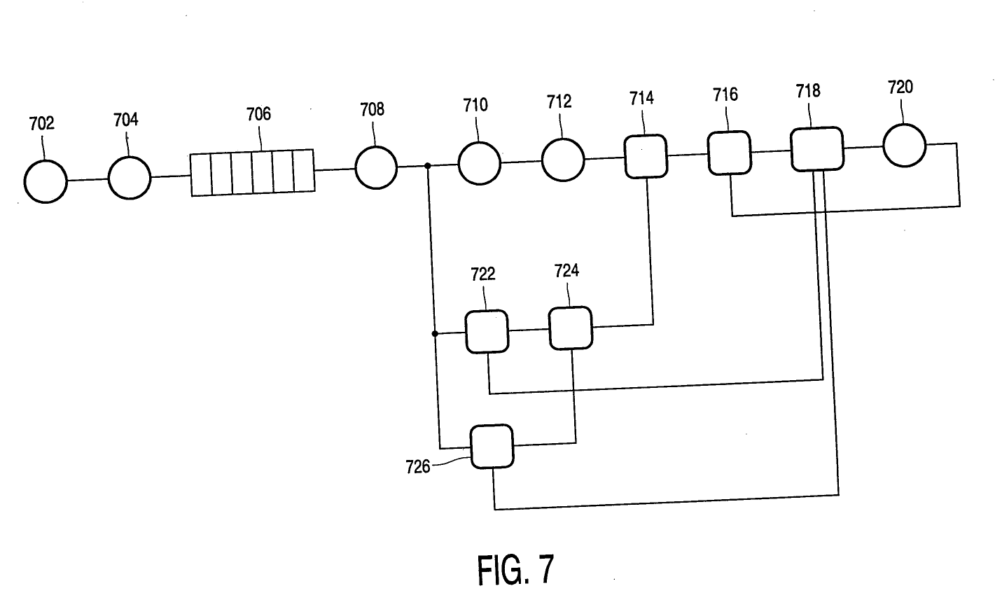

FIG. 7 illustrates, in a schematic way, the most important parts of a set-top box that comprises an embodiment of the system according to the invention;

FIG. 8 illustrates the processing tasks of an MPEG video decoder in a schematic way as a graph.

Nowadays, continuous media data processing is performed more and more by programmable components, mixtures of dedicated hardware components and programmable components, rather than dedicated single-function components. Programmable components introduce requirements for modular, flexible, maintainable and powerful architectures that enable this shift from hardware to software driven processing. This is for example the case within the real-time MPEG video processing domain wherein the data is processed by a multi-processor system. The invention relates to such streaming architectures and enables real-time execution of tasks like video encoding and transcoding such as MPEG coded video data, macroblock data and 422 video image data or multiplexing and de-multiplexing. Furthermore the invention can be applied to audio processing, VBI, IP and transport stream processing, video elementary stream or packetized elementary stream (PES) processing. In general, relates the invention to streaming architectures wherein the different processing steps can be performed by a plurality of processors. In the remainder of this description, these processors are often referred to by the term co-processors to indicate that a plurality of processors can perform a task.

Within the invention, each application that can be executed by the co-processor board is subdivided into tasks that have as much as possible in common with other tasks of other applications within the same domain. These tasks behave preferably in a streaming way that allows data to flow in and out. Data that undergoes several sequential processing steps are as much as possible processed by tasks that follow up each other as within pipelined processing. Data that can independently be processed in parallel is preferably processed by parallel tasks or by a single task that can work in parallel on multiple chunks of data, for example on multiple processors.

FIG. 1 illustrates a task 100 that reads data 106 from an input queue 102 and writes processed data 108 to an output queue 104. The input queue 102 is filled with data 110 from a preceding task and a succeeding task reads data 112 from the output queue 104. The task keeps track of the data it should process by incrementing its read pointer 114 and write pointer 116. Other techniques can be used too that enable the sequential reading from an input queue and sequential writing to an output queue. The invention does not synchronize between reading from the input queue 102 and writing to the output queue 104 by comparing the read pointer 114 and the write pointer 116, but performs the method as described below. Tasks can for example be: forward or inverse Discrete Cosine Transform (DCT) according to the MPEG specification, quantization or de-quantization according to the MPEG specification, storing frame blocks into frame memory, etc.

Multiple processors execute the task and the task has zero or more input queues and zero or more output queues, each containing one of more packets that comprise data. In general, packets are bound to a specific queue and the size and content of the packets can vary. The size of the packets within a specific queue for a predefined task is such that it enables all types of data for the predefined task to be represented accurately. Furthermore, data is passed by value. Data is only passed by reference when there's a special requirement to do so. Additionally, data can be of a specific type and a task can change the data type and generate data of another type. Within most current systems, a pointer refers to the data area. Within some current systems, the actual location of the data area, and therefore the value of the pointer, can change while processing the data. Then the system must take care of consistency between the location and the data. Since multiple processors can execute a task, these processors must be synchronized in order to prevent inconsistent usage of data. This synchronization is achieved by using a semaphore 118 that guards a sub-part of the execution of a task.

FIG. 2 illustrates a state per packet. In order to synchronize between reading from the input queue 102 and writing to the output queue 104, a state is kept per packet. This state can change from writing 200 into full 202 and from full 202 into reading 204 and from reading 204 into empty 206. This last state 206 can change into the first state 200 again. The state writing indicates that data is being written into the packet and that that the data is not consistent yet to be read, the state full indicates that data has been written and is consistent to be read, the state reading indicates that data is being read from the packet and the state empty indicates that all data has been read from the packet and it is allowed to write new data into the packet again.

FIG. 3 illustrates the states of the task's semaphore. The semaphore 118 can be in one of two states. Initially the semaphore is in state not-claimed 300. This state can change into state claimed 302 that can be changed into state not-claimed 300 again. Changing the state of the semaphore is normally done within a read-modif-write action. With the invention, this state change and the corresponding action are preferably performed within one atomic action in order to prevent inconsistent state as a result of an intervening update of an other processor.

FIG. 4 illustrates the main steps of the method according to the invention. These main steps are performed for both the decoding and encoding of a media file. The first step S400 is an initialization step in which the queues are assigned to the appropriate tasks and the tasks are assigned to the appropriate co-processors. Furthermore, tasks are subdivided into different threads and different processors can execute each thread. Within the next step S402, synchronization between the different co-processors that are eligible for executing the task, is achieved by fetching the task's semaphore 118. When the task's semaphore is not available, the specific co-processor can wait for the correct state within an additional step (not shown). The state of the semaphore 118 then changes within step S402 from not-claimed 300 into claimed 302. When the semaphore is claimed, no other processor can claim the semaphore. Only the co-processor that claims the semaphore 118 is allowed to update the task's reading and writing pointer to point them to the next packets from which data is to be read and written. The data comprised within the packet is not guarded by the semaphore. Within step S404, the task accesses the input queue and output queue in order to read the state of the input packet from the input queue as indicated by the read pointer of the task. Furthermore, the task reads the state of the output packet from the output queue as indicated by the write pointer of the task. Both read and write pointers of the task are incremented so that next time, the task reads the states of the next packets to be processed. Within step S406, the states of the packets are inspected. The task can only use full 202 packets from the input queue and empty packets 206 from the output queue. This way it is prevented that the task reads inconsistent data because the preceding task did not finish writing the data and it is prevented that the task overwrites data at the output queue, because the output packet still comprises data that must be read by the succeeding task. Note that other tasks can still change the state of the packets from reading to empty and from writing to full, because the semaphore does only guard the state change of empty to writing and of full to reading of these packets. When the state of the input packet is not full 202 or the state of the output packet is not empty 206, the co-processor that has claimed the semaphore has to wait within step S408 until both states have changed into the correct state: full 202 at the input and empty 206 at the output. Then, within step S410, the state full 202 of the input packet is changed into the state reading 204 and the state empty 206 of the output packet is changed into the state writing 200, Furthermore, when the data comprises shared data that is shared by the co-processors that execute the task, the shared data is transferred into shared memory within optional step S412. Such shared data can effect the execution of the task for all relevant co-processors, it can comprise alternate parameter sets to be handled by the task, or it can comprise specific data that only special tasks can interpret. In order to prevent inconsistent updates and/or usage of the shared data the data is furthermore copied into the own address space of a single processor. After transferring shared data into shared memory, the semaphore is released within step S414. When step S412 is not performed, step S414 succeeds step S410. The other co-processors can now start claiming the semaphore as soon as they are ready to process the next packets from the queues. Within step S416, the data is actually processed and the co-processor that processes the data can take all the time it needs for processing. When the co-processor finishes processing the data, the states of the packets are changed within step S418. The state of the input packet is changed from reading 204 into empty 206 and the state of the output packet is changed from writing 200 into full 202. Hereto, a semaphore need not be claimed, but the same co-processor can not access the packets immediately again because other tasks running on other co-processors may access the packets.

In general, the described method is independent from the number of processors assigned to a task and thereby enables a transparent speed-up of a complete application by assigning the same task to more processors without the need for redesigning the subdivision into separate tasks of the application The reassignment can be done during real-time, making the allocation of co-processors to tasks not a design issue per se. Furthermore, the described method preserves the packet order from input to output queues, independent from the difference in processing time between multiple co-processors running the same task on other packets. When a semaphore is introduced for each queue separately, the packet order may not be maintained without taking appropriate measures by for example introducing additional parameters to the packets that can be compared on equality. Hereto, sequence numbers can be used. The usage of a semaphore for each queue separately can enable a more flexible input-to-output packet ratio, for example reading one packet from the input queue and writing two or more packets from the output queue.

The order in the described embodiment of the method of the current invention is not mandatory, a person skilled in the art may change the order of steps or perform steps concurrently using threading models, multi-processor systems or multiple processes without departing from the concept as intended by the current invention.

FIG. 5 illustrates the main parts of a system according to the invention in a schematic way. The system 500 is able to both encode and decode media streams like MPEG video and audio streams. The system comprises two co-processors 502 and 504 that are assigned to execute a task that comprises multiple threads that can be executed by separate co-processors. Furthermore the system comprises an other co-processor 520 that can execute other tasks that are executable by the system. Memory 506 comprises the input queue that contains the packets with data to be processed by the task. Memory 508 comprises the output queue that contains the packets with data that has been processed by the task. The memory 510 comprises the semaphore as previously described. The task can change the contents of this memory 510 within one atomic action. Furthermore, memory 512 comprises the state of the input packet and memory 514 comprises the state of the output packet. Memory 516 comprises the waiting state of the processors 502 and 504. This memory further comprises software to determine the state of the processors whereas memory 518 comprises software that can change the state of the memories that comprise the states of the input and output packets. The shared parameters between the co-processors are comprised within memory 526 that can be updated by the task. The mentioned memories and co-processors are communicatively connected to each other via a software bus 530. Furthermore, the mentioned task is part of a multi-media application that can play audio, video, show images etc. The system 500 is realized in software intended to be operated as an application run by a computer or any other standard architecture able to operate software. The system 500 can also be realized in hardware and the system can be used to operate a digital or analogue television set 522. The software can also be updated from a storage device 524 that comprises a computer program product arranged to perform the method according to the invention. The storage device is read by a suitable reading device, for example a CD reader 528 that is connected to the system 500.

FIG. 6 illustrates a television set 610 in a schematic way that comprises an embodiment of the system according to the invention. Here an antenna, 600 receives a television signal. Any device able to receive or reproduce a television signal like, for example, a satellite dish, cable, storage device, internet, or Ethernet can also replace the antenna 600. A receiver, 602 receives the signal. The signal may be for example digital, analogue, RGB or YUV. Besides the receiver 602, the television set contains a programmable component, 604, for example a programmable integrated circuit. This programmable component contains a system according to the invention 606. A television screen 608 shows images that are received by the receiver 602 and are processed by the programmable component 604. Within an other example, when a user wants to record the received signal, for example a movie, then the system according to the invention 606 records the received signal on the recording device like a DVD+RW, a compact disk or a harddisk. Within yet an other example, when a user wants to play a recorded movie, then the system according to the invention 606 retrieves the appropriate data from the recording device.

FIG. 7 illustrates the processing tasks of an MPEG video decoder in a schematic way as a graph. The video stream is supplied by 702, a stream source. Task 704 performs the header detection and splits the stream into separate slices. This task is an indivisible task that is preferably not subdivided over multiple processors. A single slice is transferred to task 708 via buffer 706. 708 Performs the actual Huffman decoding of the slice. The decoded data now has transformed into a macroblock stream and is then split over multiple tasks. The coefficient part of the macroblock stream is used by task 710 that performs the inverse quantisation and passed on to 712 that performs the inverse DCT. The vector part of the macroblock stream is used by task 722 and 726 that perform motion compensation on forward and backward frames, respectively. Both predictions are then added and averaged by task 724 and form the final prediction. This is then added to the prediction error signal by task 714. The result is the final decoded image, and is stored into a frame memory by task 716. Task 716 gets the frame buffer references from the display task 720 that stores the free frames. Once all macroblocks of a picture have been written to the frame, the frame reference is passed to task 718, the frame manager. This frame manager decides which frames are to be used as anchor frames and which frames are to be displayed. The anchor frames are used by task 722 and 726 for the motion prediction of the next frames. The frames to be displayed are passed to task 720 that further displays the new frames and returns the old frames to the free list. Within this architecture tasks all applicable tasks can be processed by multiple co-processors wherein synchronization is performed according to the method according to the invention as previously described.

FIG. 8 illustrates, in a schematic way, the most important parts of a set-top box that comprises an embodiment of the system according to the invention. Here, an antenna 800 receives a television signal. The antenna may also be for example a satellite dish, cable, storage device, internet, Ethernet or any other device able to receive a television signal. A set-top box 802, receives the signal. The signal may be for example digital, analogue, RGB or YUV. Besides the usual parts that are contained in a set-top box, but are not shown here, the set-top box contains a system according to the invention 804. When a user wants to record the received signal, for example a movie, the system according to the invention 804 records the received signal on the recording device like a DVD+RW, a compact disk or a harddisk. When a user wants to play a recorded movie, the system according to the invention 804 retrieves the appropriate data from the recording device. The television set 806 can show the output signal generated from a received signal by the set-top box 802.

1. A method of processing a media file, the method comprising at least one processing step that is executed by a plurality of processors and the at least one processing step comprising processing data
characterized in that the at least one processing step further comprises:
a first step of claiming by one of the plurality of processors a semaphore that guards the at least one processing step;
a second step of acquiring a first processing packet from a first queue, wherein the first processing packet comprises the processing data;
a third step of waiting until the first processing packet has a first predefined state of a plurality of predefined states;
a fourth step of changing the first predefined input state of the first processing packet into a second predefined state of the plurality of predefined states;
a fifth step of releasing the semaphore by the one of the plurality of processors;
a sixth step of processing the media file comprising reading and/or writing of the processing data;
a seventh step of changing the second predefined state of the first processing packet into a third predefined state of the plurality of predefined states.

2. A method of processing a media file according to claim 1, wherein
the second step further comprises acquiring a second processing packet from a second queue;
the third step further comprises waiting until the second processing packet has the third predefined state of the plurality of predefined states;
the fourth step further comprises changing the third predefined state of the second processing packet into a fourth predefined state of the plurality of predefined states; and
the seventh step further comprises changing the fourth predefined state of the second processing packet into the first predefined state of the plurality of predefined states.

3. A method of processing a media file according to claim 1, wherein the third step further comprises a sub-step of updating a content of a shared memory, the shared memory being shared by the plurality of processors.

4. A system for processing a media file, the system (500) comprising:
a plurality of processor means (502, 504) conceived to execute at least one processing step performed upon processing data, the processing step comprising reading and/or writing the processing data;
first queue means (506) conceived to comprise a first processing packet wherein the first processing packet comprises the processing data;
characterized in that the system further comprises:
semaphore means (510) conceived to guard the processing step by one of the plurality of processors;
state means (508, 514) conceived to comprise a first predefined state of a plurality of predefined states;
waiting means (516) conceived to wait for a first predefined state for the input packet; and
changing means (518) conceived to change the first predefined state into a second predefined state of the plurality of predefined states.

5. A system of processing a media file according to claim 4, wherein the system further comprises:
second queue means (508) conceived to comprise a second packet, wherein the second packet comprises second processing data;
the state means (508, 514) is further conceived to comprise a third predefined state of the plurality of predefined states; and
the changing means (518) is further conceived to change the third predefined state into a fourth predefined state of the plurality of predefined states.

6. A system of processing a media file according to claim 5, wherein the system (500) further comprises memory means (526) conceived to comprise shared content for the plurality of processors.

7. A computer program product designed to perform the method according to any of the claims 1 to 3.

8. A storage device (524) comprising a computer program product according to claim 7.

9. A television set (600) comprising a system according to any of the claims 4 to 6.

10. A set-top box (700) comprising a system according to any of the claims 4 to 6.
